(19) United States
(12) Patent Application Publication
(10) Pub. No.: US 2023/0298205 A1
(43) Pub. Date: Sep. 21, 2023

(54) SKELETON DETECTION SYSTEM

(71) Applicant: Hitachi Kokusai Electric Inc., Tokyo (JP)

(72) Inventors: Keiichi HIROKI, Tokyo (JP); Toshiaki TARUI, Tokyo (JP); Shun FUKUDA, Tokyo (JP); Kenichi MORITA, Tokyo (JP); Yoshiki ITO, Tokyo (JP)

(73) Assignee: Hitachi Kokusai Electric Inc., Tokyo (JP)

(21) Appl. No.: 18/043,593

(22) PCT Filed: Apr. 5, 2021
(86) PCT No.: PCT/JP2021/014516

§ 371 Date: Mar. 1, 2023

(30) Foreign Application Priority Data
Sep. 2, 2020 (JP) 2020-147563

(51) Int. Cl. G06T 7/73

(52) U.S. Cl. CPC G06T 7/74; G06T 2200/28; G06T 2207/10016; G06T 2207/20081; G06T 2207/20092; G06T 2207/30196; G06T 2207/30242

(57) ABSTRACT

A skeleton detection system stores a target image for use in skeleton detection, and a plurality of skeleton detection models respectively corresponding to a plurality of skeleton definition models for defining different skeletons. The skeleton detection system determines a predetermined condition for the skeleton detection of the target image, selects a first skeleton detection model from the plurality of skeleton detection models based on a result of the determination, and executes the skeleton detection of the target image by the first skeleton detection model.

### CROSS-REFERENCE TO RELATED APPLICATIONS

The present application claims priority from Japanese Patent Application No. 2020-147563 filed on Sep. 2, 2020, and contents of which are incorporated into the present application by reference.

### TECHNICAL FIELD

The present invention relates to a technique of skeleton detection of an image.

### BACKGROUND ART

There are many attempts to estimate a skeleton or a posture of a person in a frame image in a still image or a moving image, and this is called skeleton detection or posture estimation. In these techniques, generally, a method of estimating a position of a specific part such as a joint or a head of a person in an image is widely used.

In recent years, many skeleton detection methods based on machine learning are proposed and have high accuracy. PTL 1 describes processing of acquiring a 3D shape with high validity by evaluating a degree of matching between a result of skeleton detection and an estimation result of person outline data and a posture of a person by a 3D sensor. PTL 2 discloses a technique that extracts feature data for each part based on a result of skeleton detection and implements personal authentication using a physical feature.

### CITATION LIST

### Patent Literature

PTL 1: US2013/0250050
PTL 2: US2019/0278985

### SUMMARY OF INVENTION

### Technical Problem

In a skeleton detection method in the related art, a detection accuracy is reduced depending on a state of a target person. For example, a skeleton detection accuracy of a person whose details are unclear because the person is far away, or a person whose body is partially hidden by a crowd, a shield, or the like is reduced. Alternatively, since the skeleton detection method in the related art has a high calculation cost, when a skeleton detection function is implemented in a device having a small calculation resource such as an edge device or a mobile device, the skeleton detection function does not operate due to a resource shortage, or an operation speed thereof is slow.

### Solution to Problem

A skeleton detection system according to an aspect of the invention includes one or more arithmetic devices and one or more storage devices. The one or more storage devices store a target image for use in skeleton detection, and a plurality of skeleton detection models respectively corresponding to a plurality of skeleton definition models defining different skeletons. The one or more arithmetic devices determine a predetermined condition for skeleton detection of the target image, select a first skeleton detection model from the plurality of skeleton detection models based on a result of the determination, and execute the skeleton detection of the target image by the first skeleton detection model.

### Advantageous Effects of Invention

According to the aspect of the invention, the resource saving skeleton detection can be executed with high accuracy and high speed. Further features related to the invention are clarified based on the description of the present specification and accompanying drawings. In addition, problems, configurations, and effects other than those described above will be clarified by the description of the following embodiments.

### BRIEF DESCRIPTION OF DRAWINGS

FIG. 1 shows a long-distance skeleton definition model corresponding to a long-distance skeleton detection model.

FIG. 2 shows a crowd skeleton definition model corresponding to a crowd skeleton detection model.

FIG. 3 is a configuration diagram of a skeleton detection system.

FIG. 4 is a configuration diagram of a skeleton detection model selection unit.

FIG. 5 shows an example of a skeleton detection result displayed on an output device.

FIG. 6 shows an example of a skeleton detection result displayed on the output device.

FIG. 7 shows a flowchart of an operation of the skeleton detection system.

FIG. 8A shows a configuration example of a skeleton definition model summary table.

FIG. 8B shows a configuration example of a keypoint data table.

FIG. 8C shows a configuration example of a skeleton data table.

FIG. 9 shows a configuration example of a skeleton detection result data table.

FIG. 10A is a flowchart illustrating an operation of the skeleton detection model selection unit.

FIG. 10B is a flowchart illustrating an operation of the skeleton detection model selection unit.

FIG. 11A shows an example of a skeleton definition model.

FIG. 11B shows an example of the skeleton definition model.

FIG. 11C shows an example of the skeleton definition model.

### DESCRIPTION OF EMBODIMENTS

Hereinafter, embodiments of the invention will be described in detail with reference to drawings. Description may be divided into a plurality of sections or embodiments if necessary for convenience. Unless otherwise specified, the sections or embodiments are not independent of each other, but have a relation in which a section or embodiment is a modification, detailed description, supplementary description, or the like of a part or all of another section or embodiment. In the following description, when a number or the like (including a number, a numeric value, an amount, a range, and the like) of an element is referred to, the number or the like is not limited to a specific number, and may be equal to and greater than, or equal to and less than the specific number, unless otherwise specified or clearly limited to the specific number in principle.

A system may be a physical computer system (one or more physical computers) or a system constructed on a calculation resource group (a plurality of calculation resources) such as a cloud infrastructure. The computer system or the calculation resource group includes one or more interface devices (including, for example, a communication device and an input and output device), one or more storage devices (including, for example, a memory (main storage) and an auxiliary storage device), and one or more arithmetic devices.

When a function is implemented by executing a program including an instruction code by the arithmetic device, the function may be at least a part of the arithmetic device since predetermined processing is appropriately performed using the storage device and/or the interface device. Processing described with the function serving as a subject may be processing performed by the arithmetic device or a system including the arithmetic device. The program may be installed from a program source. The program source may be, for example, a program distribution computer or a computer-readable storage medium (for example, a computer-readable non-transitory storage medium). A description for each function is an example, and a plurality of functions may be combined into one function, or one function may be divided into a plurality of functions.

In the following description, estimating a position of a specific part such as a joint or a head of an animal including a person in an image is referred to as “skeleton detection”. The position of the specific part is referred to as a “keypoint”. The keypoints are, for example, a neck, a knee, and an elbow. A connection relation between keypoints is referred to as “skeleton”. The skeleton is, for example, a set of keypoints having a connection relation such as a knee and an ankle, a shoulder and an elbow.

A skeleton detection method described below implements the resource saving skeleton detection with high accuracy and high speed by selecting a skeleton detection model suitable for the skeleton detection in an image from a plurality of skeleton detection models. The resource saving means that an occupation amount of the calculation resources such as a CPU, a GPU, and a RAM of the computer is small.

An example of the skeleton detection system described below holds a plurality of skeleton detection models trained in advance, and selects a skeleton detection model according to a skeleton detection scene. The skeleton detection scene is information related to skeleton detection of a target image, and includes information related to a content of the target image, information related to a content of the image before an imaging time of the target image, information input by a user for use in the skeleton detection, information related to the arithmetic resource of the computer in which a skeleton detection function is implemented, information related to an imaging device of the image, and the like.

The plurality of skeleton detection models are trained based on different skeleton definition models. The different skeleton definition models are configured with keypoints or skeletons of different numbers or different types. In comparison with the skeleton definition models corresponding to all the skeleton detection scenes, in the skeleton definition models configured to be suitable for different skeleton detection scenes, the number of one or both of the keypoints and the skeletons is reduced.

By deleting or integrating the keypoints, it is possible to reduce the number of the keypoints and the skeletons. The integration of the keypoints is to replace a plurality of keypoints with one or fewer keypoints than the original by recalculation. The skeleton detection includes processing of increasing a calculation cost in proportion to the number of keypoints and skeletons, and thus the high-speed and the resource saving can be achieved by reducing the number of the keypoints and skeletons.

The skeleton detection model stores a relation between the image and the keypoints and skeletons in a finite dimensional feature data space. Therefore, as a result of the reduction in the number of the keypoints and skeletons to be detected, the feature data space allocated to each of the keypoints or the skeletons increases, and a detection accuracy of each of the keypoints increases. If a certain keypoint is not detected, the detection accuracy of another keypoint connected to the keypoint and the skeleton is reduced, but this can be avoided by appropriately selecting a keypoint and constructing a skeleton definition model.

As described above, by configuring the skeleton detection model using the skeleton definition model in which the number of the keypoints and skeletons are reduced, it is possible to implement both high accuracy, high speed, and resource saving in the skeleton detection. On the other hand, since the keypoint that is not included in the skeleton definition model is not detected, an appropriate skeleton detection model (skeleton definition model) is selected according to the skeleton detection scene.

The skeleton detection method according to an embodiment of the present specification can execute the resource saving skeleton detection with high accuracy and high speed. The number of the keypoints detected by the skeleton detection method is reduced, and an appropriate keypoint can be detected according to the skeleton detection scene by the skeleton detection method.

### First Embodiment

Hereinafter, a skeleton detection system according to an embodiment of the present specification will be described. The skeleton detection system in the present embodiment receives a still image or a frame image in a moving image captured by a monitoring camera, and determines a predetermined condition for skeleton detection of the image. The skeleton detection system refers to information of the skeleton detection scene of the target image, and determines the predetermined condition for the skeleton detection.

The skeleton detection system selects a skeleton detection model for detecting a skeleton from the image among the plurality of skeleton detection models based on a determination result. The skeleton detection system performs skeleton detection processing on the image using the selected skeleton detection model.

Information included in the skeleton detection scene in the present embodiment will be described. The skeleton detection scene of the present embodiment includes a detection rate of each keypoint of a past frame image, the number of persons in the past frame image, an estimated distance between the camera and the person in the past frame image, and a purpose of skeleton detection designated by the user. The skeleton detection system selects a skeleton detection model for the target image based on the information.

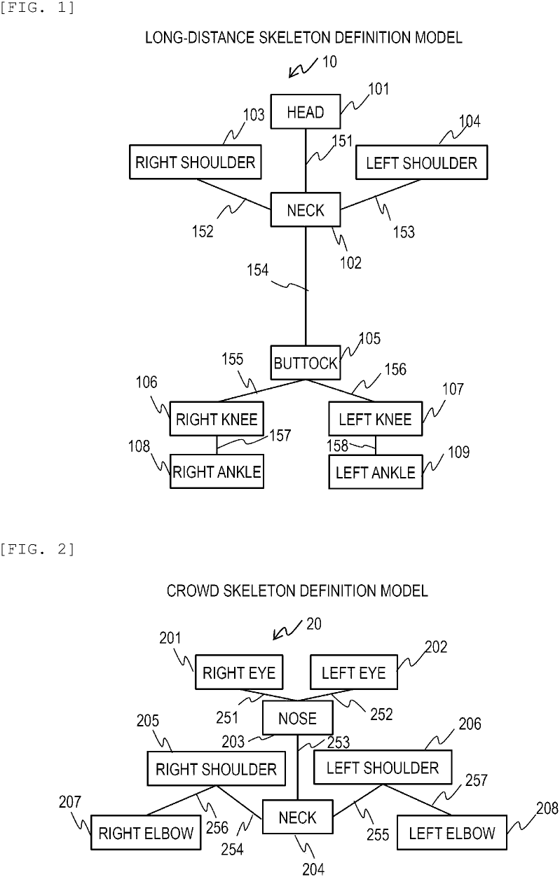

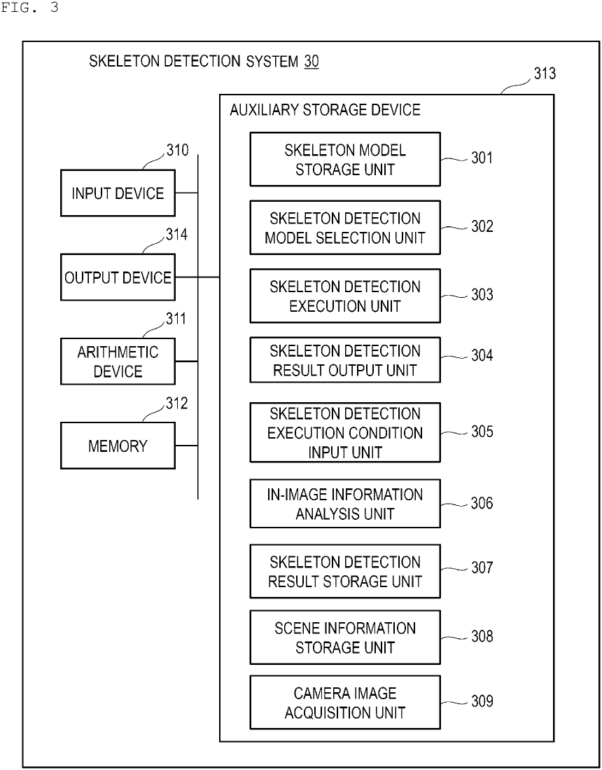

A skeleton detection model selectable in an example described below is configured with two types of skeleton detection models, specifically, a long-distance skeleton detection model and a crowd skeleton detection model. FIG. 1 shows a long-distance skeleton definition model 10 corresponding to the long-distance skeleton detection model. FIG. 2 shows a crowd skeleton definition model 20 corresponding to a crowd skeleton detection model. In the figures, a rectangle represents a keypoint, and a straight line by which the keypoints are connected represents a skeleton.

The long-distance skeleton definition model 10 defines keypoints of a head 101, a neck 102, a right shoulder 103, a left shoulder 104, a buttock 105, a right knee 106, a left knee 107, a right ankle 108, and a left ankle 109. The long-distance skeleton definition model further defines a skeleton 151 between the head and the neck, a skeleton 152 between the neck and the right shoulder, a skeleton 153 between the neck and the left shoulder, a skeleton 154 between the neck and the buttock, a skeleton 155 between the buttock and the right knee, a skeleton 156 between the buttock and the left knee, a skeleton 157 between the right knee and the right ankle, and a skeleton 158 between the left knee and the left ankle.

The long-distance skeleton definition model 10 does not include a keypoint of a part having a small size, such as a wrist, an elbow, an eye, a nose, a mouth, or an ear. The keypoints of the long-distance skeleton model are configured with large parts which are easily seen even from a distance. Therefore, the long-distance skeleton detection model is suitable for detecting a person at a distance with high speed and high accuracy.

FIG. 2 shows the crowd skeleton definition model 20 corresponding to the crowd skeleton detection model. The crowd skeleton definition model 20 defines keypoints of a right eye 201, a left eye 202, a nose 203, a neck 204, a right shoulder 205, a left shoulder 206, a right elbow 207, and a left elbow 208.

The crowd skeleton definition model 20 further defines a skeleton 251 between the right eye and the nose, a skeleton 252 between the left eye and the nose, a skeleton 253 between the nose and the neck, a skeleton 254 between the neck and the right shoulder, a skeleton 255 between the neck and the left shoulder, a skeleton 256 between the right shoulder and the right elbow, and a skeleton 257 between the left shoulder and the left elbow.

The crowd skeleton definition model 20 does not include keypoints of a lower body such as the buttock, the knee, and the ankle. The keypoints of the crowd skeleton model are configured with parts of an upper body which are easily seen even if persons overlap with each other. Therefore, the crowd skeleton detection model is suitable for detecting a skeleton of a person in a crowd in which many persons overlap with each other with the high speed and the high accuracy.

These skeleton definition models are configured with fewer keypoints than skeleton definition models of the skeleton detection method in the related art, and thus it is possible to implement the high accuracy, the high speed, and the resource saving. These skeleton definition models include many keypoints common to the skeleton definition models of the skeleton detection method in the related art, and non-common keypoints can also calculate a coordinate by integrating a plurality of keypoints. For example, a position of a head keypoint can be determined by taking a center of gravity of the keypoints of the right eye, the left eye, the nose, and the mouth. Accordingly, it is possible to implement the skeleton detection with the high accuracy by utilizing a training data set used in the skeleton detection method in the related art.

In a configuration example described below, a skeleton detection model is selected based on an image captured by a monitoring camera. In another configuration example, a plurality of monitoring cameras may cooperate with each other, and a skeleton model may be selected based on information obtained by another monitoring camera.

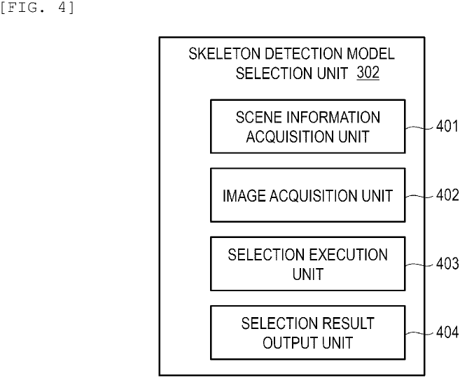

FIG. 3 is a configuration diagram of the skeleton detection system of the present embodiment. FIG. 4 is an example of a configuration diagram of a skeleton detection model selection unit 302. The skeleton detection system 30 includes an input device 310, an output device 314, an arithmetic device 311, a memory 312, and an auxiliary storage device 313. The input device 310 includes a communication interface with the monitoring camera, and receives an input of an image. The input device 310 includes a human interface such as a mouse and a keyboard, and receives an input to the skeleton detection system 30 by the user. The output device 314 includes a display, a printer, and the like that output an arithmetic result from the skeleton detection system 30, or a communication interface with another device such as a server.

The auxiliary storage device 313 stores various programs for implementing analysis processing executed by the skeleton detection system 30, execution results of the processing, and the like. The auxiliary storage device 313 stores processing programs of the skeleton detection model selection unit 302, a skeleton detection execution unit 303, a skeleton detection result output unit 304, a skeleton detection execution condition input unit 305, an in-image information analysis unit 306, and a camera image acquisition unit 309. Further, the auxiliary storage device 313 includes a skeleton model storage unit 301, a skeleton detection result storage unit 307, and a scene information storage unit 308. The above units are databases (data files).

Various programs and data stored in the auxiliary storage device 313 are loaded into the memory 312. The arithmetic device 311 executes the program loaded in the memory 312 to operate as a corresponding functional unit, and is configured with, for example, one or more CPUs, a GPU, or the like. The processing and the arithmetic described below are executed by the arithmetic device 311.

The skeleton model storage unit 301 stores a plurality of skeleton detection models and skeleton definition models respectively corresponding to the skeleton detection models. The skeleton detection model is a machine learning model, and is, for example, a neural network. The skeleton detection model receives an image, and outputs a detection result of each keypoint as an in-image coordinate.

Types of keypoints output by the plurality of skeleton detection models are different from each other. For example, a skeleton detection model A outputs keypoints of eyes, a nose, an ear, a mouth, a neck, a right shoulder, a left shoulder, a right elbow, a left elbow, a right wrist, a left wrist, a right buttock, a left buttock, a right knee, a left knee, a right ankle, and a left ankle. A skeleton detection model B outputs keypoints of a head, the neck, the right shoulder, the left shoulder, the buttock, the right knee, the left knee, the right ankle, and the left ankle.

Different skeleton detection models have different definitions for skeletons that are connection relations between keypoints. For example, a skeleton detection model C includes a skeleton in which the right shoulder and the left shoulder are connected, but a skeleton detection model D does not have the skeleton in which the right shoulder and the left shoulder are connected. The skeleton detection model is statistically generated (trained) from a large amount of accumulated images of a person, and determines which color or shape in the image is highly likely to be each keypoint or skeleton.

The skeleton detection model selection unit 302 selects a skeleton detection model to be executed from a plurality of skeleton detection models stored in the skeleton model storage unit 301 based on information on a skeleton detection scene acquired from the scene information storage unit 308. In the present embodiment, the skeleton detection model is selected based on a detection rate of each keypoint of the past frame image, the number of persons in the past frame image, an estimated distance between the camera and the person, and a purpose of the skeleton detection designated by the user. A distance between the camera and the person can be estimated based on a size of the person in the image and the in-image coordinate.

The skeleton detection execution unit 303 uses a skeleton detection model selected by the skeleton detection model selection unit 302 among the skeleton detection models stored in the skeleton model storage unit 301 to perform skeleton detection processing of inputting a current image and outputting a detection result of a keypoint. The skeleton detection result output unit 304 outputs information obtained from a skeleton detection result output from the skeleton detection execution unit 303 to the output device 314. The skeleton detection result output unit 304 outputs information of a predetermined type to the output device 314 for the skeleton detection result. The skeleton detection result output unit 304 may output, for example, a detection result of an intruder, the number of persons, an image in which the input image and a detection skeleton are overlapped, or the like.

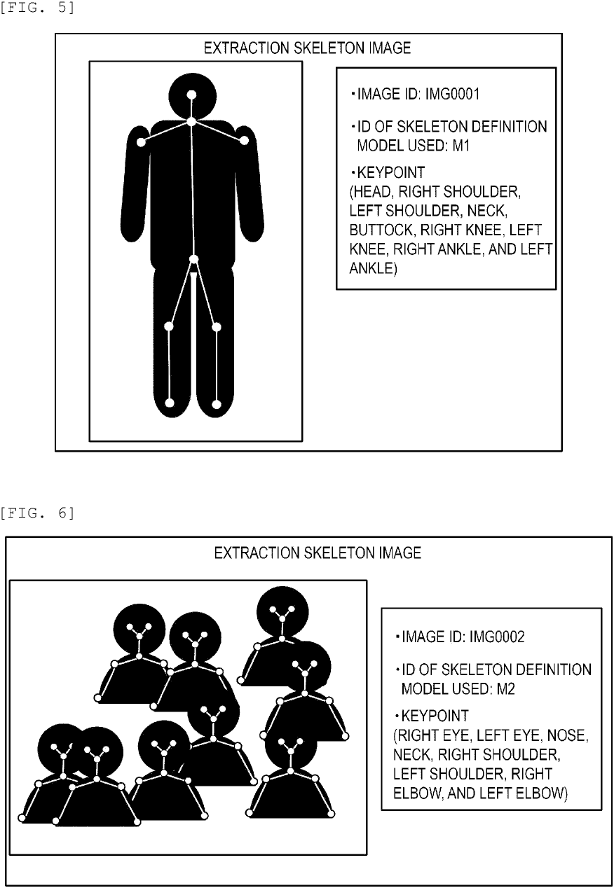

FIGS. 5 and 6 show an example of the skeleton detection result displayed on the output device 314. The detection result image of FIG. 5 shows a skeleton detected by the long-distance skeleton detection model and information on the used skeleton detection model together. As described above, the long-distance skeleton detection model detects keypoints of a whole body from the head to the ankle, and detects a keypoint of a relatively large part which can be detected even from a distance. The detection result image of FIG. 6 shows a skeleton detected by the crowd skeleton detection model and information on the used skeleton detection model together. As described above, the crowd skeleton detection model detects keypoints of an upper body that can be easily seen even when the persons overlap with each other.

Returning to FIG. 3, the skeleton detection execution condition input unit 305 acquires information on the skeleton detection scene from the user via the input device 310, and stores the information in the scene information storage unit 308. In the present embodiment, the purpose of performing the skeleton detection is input by the user. In the present embodiment, the user selects the purpose of performing the skeleton detection from among “number-of-persons count”, “intruder detection”, “specific activity detection”, and “no selection”.

The in-image information analysis unit 306 acquires an input image from the camera image acquisition unit 309, and acquires a skeleton detection result of one or more past (before input images) frame images from the skeleton detection result storage unit 307. The in-image information analysis unit 306 analyzes the skeleton detection result of the past frame image, acquires the information on the skeleton detection scene of the input image, and stores the information in the scene information storage unit 308.

In the present embodiment, the in-image information analysis unit 306 acquires and outputs a detection rate of each keypoint, the number of persons in the image, and the estimated distance between the camera and the person in each of the past frame images. The detection rate of each keypoint is a rate at which each keypoint is detected for a person in the image, and is a value obtained by dividing the number of detected keypoints by the number of the persons in the image.

A method of acquiring the number of persons in the image is, for example, to count the number of the heads of the persons by using the skeleton detection result. A method of estimating the distance between the camera and the person can estimate the distance according to a size of the person in the image by using the skeleton detection result. Alternatively, when information on an angle of view of the camera and a shape of ground is known, a distance estimation method can estimate the distance from an in-image coordinate of the ankle of the person. For example, the distances of all the persons whose distances in the image can be estimated are estimated.

The skeleton detection result storage unit 307 stores the result of the skeleton detection output by the skeleton detection execution unit 303 and the skeleton detection model in which the result is output. The stored information is acquired by the in-image information analysis unit 306 as necessary.

The scene information storage unit 308 stores information on the skeleton detection scene output from the in-image information analysis unit 306 and the skeleton detection execution condition input unit 305. The camera image acquisition unit 309 acquires an image from the camera connected to the skeleton detection system 30, and outputs the image to the in-image information analysis unit 306 and the skeleton detection execution unit 303.

FIG. 4 shows a logical configuration example of the skeleton detection model selection unit 302. The skeleton detection model selection unit 302 includes a scene information acquisition unit 401, an image acquisition unit 402, a selection execution unit 403, and a selection result output unit 404.

The scene information acquisition unit 401 acquires scene information from the scene information storage unit 308. In the present embodiment, the scene information includes a past skeleton detection result and a purpose of performing the skeleton detection input by the user. The image acquisition unit 402 receives an input of the camera image from the camera image acquisition unit 309. The selection execution unit 403 selects a skeleton detection model to be used in the skeleton detection based on the input scene information and image. The selection result output unit 404 outputs a selection result of the skeleton detection model to the skeleton detection execution unit 303.

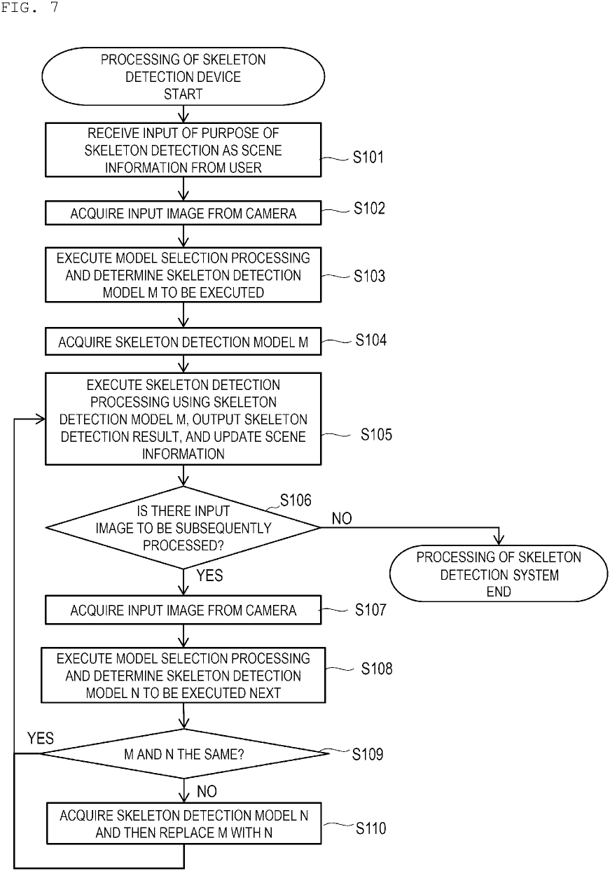

Next, operations of the skeleton detection system 30 of the present embodiment will be described with reference to a flowchart of FIG. 7. In step S101, the skeleton detection execution condition input unit 305 receives the input of the purpose of performing the skeleton detection by the user, and records the input in the scene information storage unit 308. In step S102, the camera image acquisition unit 309 acquires the input image on which the skeleton detection processing is performed. In step S103, the skeleton detection model selection unit 302 executes model selection processing, and determines a skeleton model M used in the skeleton detection processing.

In step S104, the skeleton detection execution unit 303 acquires the skeleton model M determined in step S103 from the skeleton model storage unit 301. In step S105, the skeleton detection execution unit 303 executes the skeleton detection processing using the skeleton model M, and stores the skeleton detection result in the skeleton detection result storage unit 307. The skeleton detection result output unit 304 outputs information based on the skeleton detection result to the output device 314. The scene information of the scene information storage unit 308 is updated based on the skeleton detection result. In step S106, the skeleton detection model selection unit 302 determines whether there is an input image to be subsequently processed. When there is a next input image (S106: YES), the process proceeds to step S107, and when there is no next input image (S106: NO), the processing of the skeleton detection system ends.

In step S107, the skeleton detection model selection unit 302 acquires the input image to be subsequently processed. In step S108, the skeleton detection model selection unit 302 executes the model selection processing using the updated scene information, and determines a skeleton detection model N used in the next skeleton detection processing. When the model M and the model N are the same skeleton detection model (S109: YES), a flow returns to step S105, and when the model M and the model N are different skeleton detection models (S109: NO), the flow proceeds to step S110. In step S110, the skeleton detection execution unit 303 acquires the skeleton detection model N determined in step S108 from the skeleton model storage unit 301. The flow then replaces the skeleton detection model M with the skeleton detection model N, and returns to step S105.

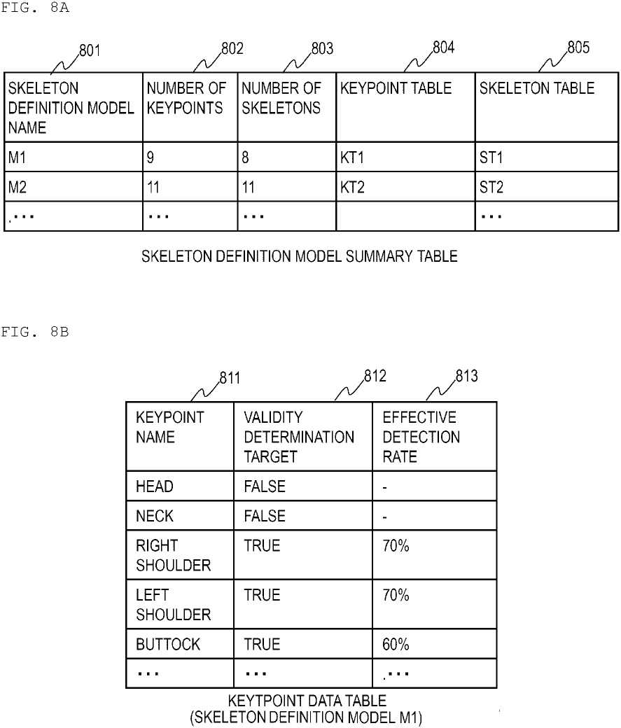

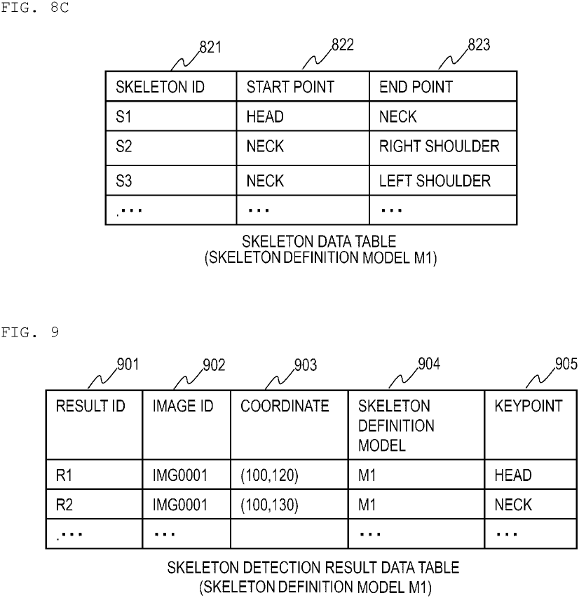

Here, a data configuration example of the skeleton definition model, the keypoint information of the skeleton definition model, the skeleton information of the skeleton definition model, and the skeleton detection result will be described with reference to FIGS. 8A to 8C and FIG. 9. FIGS. 8A to 8C show a data structure representing the skeleton definition model, in which FIG. 8A shows a configuration example of a skeleton definition model summary table, FIG. 8B shows a configuration example of a keypoint data table, and FIG. 8C shows a configuration example of a skeleton data table.

The skeleton definition model summary table shown in FIG. 8A indicates summary information of each different skeleton definition model. The skeleton definition model summary table includes a skeleton definition model name column 801, a number-of-keypoint column 802, a number-of-skeleton column 803, a keypoint table column 804, and a skeleton table column 805.

The skeleton definition model name column 801 indicates a name of each skeleton definition model. A model name uniquely identifies a skeleton definition model. The number-of-keypoint column 802 and the number-of-skeleton column 803 indicate the number of keypoints and the number of skeletons which constitute the skeleton definition model, respectively. The number of the keypoints and the number of the skeletons are also indices of a calculation cost of a model.

The keypoint table column 804 indicates a link to the keypoint data table indicating detailed information of the keypoint of the skeleton definition model. The skeleton table column 805 indicates a link to the skeleton data table indicating detailed information of the skeleton of the skeleton definition model. Hereinafter, the skeleton definition model M1 will be described as an example.

FIG. 8B shows a configuration example of the keypoint data table of the skeleton definition model M1. The keypoint data table includes a keypoint name column 811, a validity determination target column 812, and an effective detection rate column 813.

The keypoint name column 811 indicates a list of keypoints included in the skeleton model. The keypoint name uniquely identifies the keypoint in the skeleton definition model. The validity determination target column 812 indicates whether each keypoint is a keypoint used in validity determination processing of a model performed by the skeleton detection model selection unit 302. The effective detection rate column 813 indicates an effective detection rate when the keypoint is used.

FIG. 8C shows a configuration example of a skeleton data table of the skeleton definition model M1. The skeleton data table includes a skeleton ID column 821, a start point column 822, and an end point column 823. The skeleton ID column 821 shows a list of IDs of the skeleton included in the skeleton definition model. The start point column 822 and the end point column 823 indicate a start point keypoint and an end point keypoint to which each skeleton is connected.

As described above, the skeleton definition model defines keypoints and skeletons of the skeleton to be detected. The skeleton detection model corresponding to the skeleton definition model performs training according to definitions of these keypoints and skeletons. The skeleton detection model trained according to the skeleton definition model outputs coordinates of the detected keypoints to the input image. A training method is a well-known technique, and a description thereof will be omitted.

FIG. 9 shows a configuration example of a skeleton detection result data table showing a detection result by the skeleton detection model. The skeleton detection result data table includes a result ID column 901, an image ID column 902, a coordinate column 903, a skeleton definition model column 904, and a keypoint column 905. The result ID column 901 indicates an ID of a detection result. The image ID column 902 indicates an ID of an image to be detected. For example, the image ID is a serial number, and the front and rear frames can be known from the image ID. The coordinate column 903 indicates coordinates in an image, and is shown in a form of (x coordinate, y coordinate). The skeleton definition model column 904 indicates a skeleton definition model corresponding to a skeleton detection model used for the skeleton detection. The keypoint indicates which keypoint in the skeleton definition model is the keypoint.

Next, an operation of the skeleton detection model selection unit 302 will be described. The skeleton detection model selection unit 302 receives the scene information and the input image, and outputs the selection result of the skeleton detection model. In the present embodiment, the skeleton detection model selection unit 302 selects one of the two types of skeleton detection models that are the long-distance skeleton detection model and the crowd skeleton detection model. The number of skeleton detection models to be prepared may be three or more.

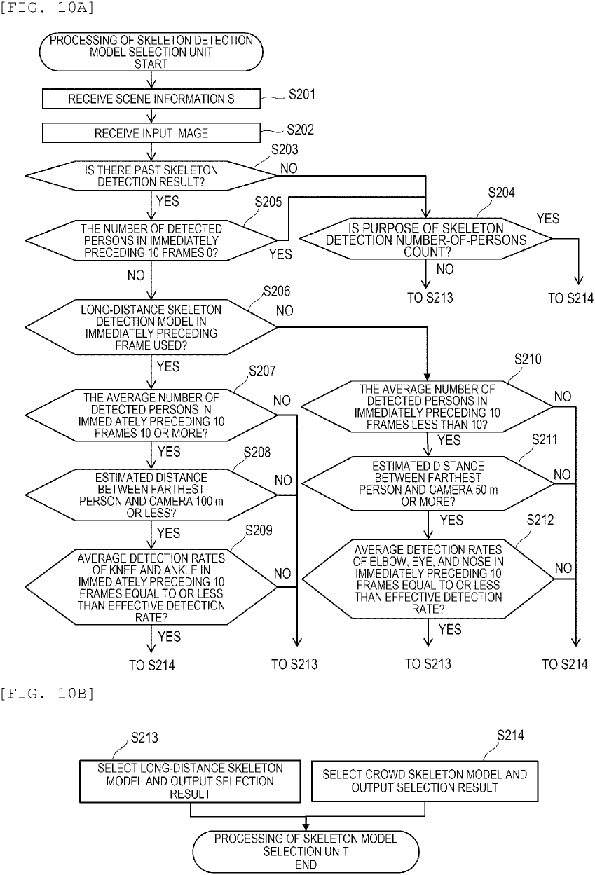

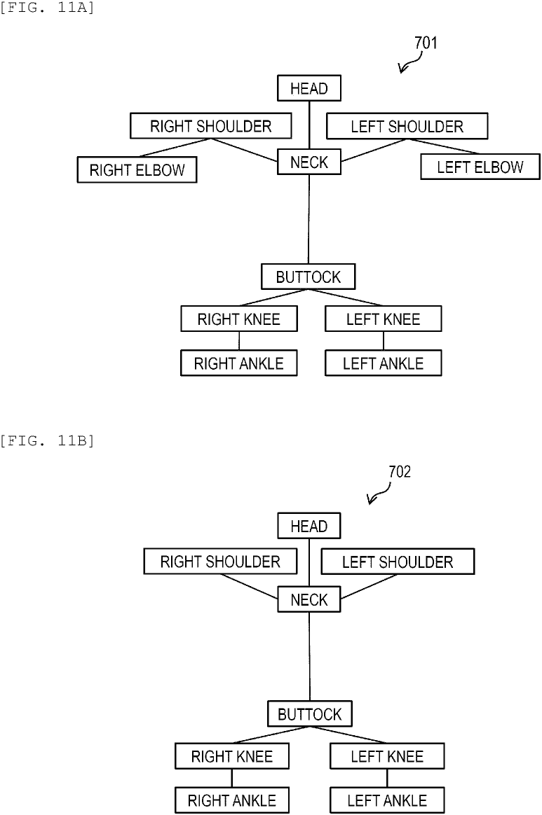

FIGS. 10A and 10B are flowcharts illustrating the operation of the skeleton detection model selection unit 302. In step S201, a scene information acquisition unit 401 receives scene information S. In the present embodiment, the scene information acquisition unit 401 receives, as scene information, a skeleton detection result in the past frame image and the purpose of performing the skeleton detection designated by the user.

In the present embodiment, it is assumed that the purpose of performing the skeleton detection is any one of the “number-of-persons count”, the “intruder detection”, the “specific activity detection”, and the “no selection”. In step S202, the image acquisition unit 402 receives the input image. In step S203, the selection execution unit 403 determines whether there is a skeleton detection result in the past frame image.

In step S103 of the skeleton detection system processing flow described with reference to FIG. 7, the skeleton detection result of the past frame image is not present, and in step S108, the skeleton detection of the past frame image is present. When there is no past detection result (S203: NO), the flow proceeds to step S204.

In step S204, the selection execution unit 403 performs a branch determination according to the purpose of the skeleton detection. When the purpose of the skeleton detection is “number-of-persons count”, the selection execution unit 403 selects a skeleton model for a crowd (step S213). When the purpose of the skeleton detection is “intruder detection” or “no setting”, the selection execution unit 403 selects a skeleton model for a long distance (step S214). The selection result output unit 404 outputs the selection result of the skeleton detection model, and the processing of the skeleton detection model selection unit 302 ends.

Returning to step S203, when there is a detection result of the past frame image (S203: YES), the flow proceeds to step S205. In step S205, the selection execution unit 403 calculates the total number of the detected persons of the past 10 frame images using the past skeleton detection result. In a case where the total number of the detected persons is 0 (S205: YES), since there is no past detection result that can be referred to, the flow proceeds to step S204.

When the total number of the detected persons is one or more (S205: NO), the flow proceeds to step S206. In step S206, the selection execution unit 403 performs the branch determination based on the skeleton model used in the skeleton detection of an immediately preceding frame image. When the used skeleton model is for the long distance, the process proceeds to step S207.

In step S207, the selection execution unit 403 calculates the average number of detected persons in the immediately preceding 10 frame images by using the past skeleton detection result, and determines whether the average number of the detected persons is ten or more. When the average number of the detected persons is less than 10 (S207: NO), the flow proceeds to step S213, and the selection execution unit 403 selects a long-distance skeleton model. When the average number of the detected persons is ten or more (S207: YES), the flow proceeds to step S208. In this way, by referring to the detection results of a plurality of past frame images, a more appropriate selection can be made.

In step S208, an estimated distance between a farthest person and the camera is calculated using a skeleton detection result of the past frame image. For example, the selection execution unit 403 refers to the immediately preceding 10 frame images. For example, an approximate distance can be calculated according to the size in the image of the person. Alternatively, when the information on the angle of view of the camera and the shape of the ground is known, the approximate distance can be calculated from the in-image coordinate of the ankle of the person. When the estimated distance to the farthest person is longer than 100 m (S208: NO), the selection execution unit 403 proceeds to step S213 to select the long-distance skeleton model. When the estimated distance is 100 m or less, the process proceeds to step S209.

In step S209, the selection execution unit 403 performs the branch determination based on the detection rate of the keypoint in the immediately preceding 10 frame images. As described with reference to FIG. 8B, the keypoint data table indicates whether each keypoint in the skeleton model is a validity determination target, and further indicates an effective detection rate of a validity determination target. The selection execution unit 403 determines whether the average detection rate in the immediately preceding 10 frame images exceeds the designated effective detection rate for each keypoint of the validity determination target.

Here, as an example, the right knee, the left knee, the right ankle, and the left ankle are the keypoints of the validity determination target. A low detection rate of these keypoints means an angle of view in which the lower body cannot be seen. Further, since the number of persons in the image is larger than that of the branch condition in step S207, there is a high possibility that the crowd skeleton model is more suitable.

Therefore, when the average detection rate in the immediately preceding 10 frame images is equal to or less than the effective detection rate for all the keypoints that are the validity determination targets (S209: YES), the selection execution unit 403 proceeds to step S214 to change the skeleton model to a model for the crowd. Otherwise (S209: NO), the selection execution unit 403 proceeds to step S213 to select the long-distance skeleton model.

Next, the process returns to step S206, and when the skeleton detection model used in the skeleton detection of the immediately preceding frame is used for the crowd (S206: NO), the flow proceeds to step S210. In step S210, as in step S207, the selection execution unit 403 performs the branch determination with the average number of the detected persons in the immediately preceding 10 frame images. When the average number of the detected persons is 10 or more (S210: NO), the selection execution unit 403 proceeds to step S214 to select the crowd skeleton model. When the average number of the detected persons is less than 10 (S210: YES), the flow proceeds to step S211.

In step S211, similarly to step S208, the selection execution unit 403 performs the branch determination based on the estimated distance between the camera and the person. For example, the selection execution unit 403 refers to the immediately preceding 10 frame images. When the estimated distance to the farthest person is less than 50 m (S211: NO), the selection execution unit 403 proceeds to step S214 to select the crowd skeleton model. When the estimated distance is equal to or greater than 50 m (S211: YES), the flow proceeds to step S212.

In step S212, similarly to step S209, the selection execution unit 403 performs the branch determination based on the detection rate of the keypoint in the immediately preceding 10 frame images. Here, as an example, detection rates of keypoints of the right elbow, the right knee, the right eye, the left eye, and the nose are determined as determination targets.

A low detection rate of these keypoints means an angle of view at which a part at an end of a body or a small part cannot be seen. Further, depending on the branch condition of step S211, the distance to the person is large. Therefore, there is a high possibility that the long-distance skeleton model is suitable.

Therefore, when the average detection rate in the immediately preceding 10 frame images is equal to or less than the effective detection rate for all the keypoints that are the validity determination targets (S212: YES), the selection execution unit 403 proceeds to step S213 to change the skeleton model to a model for the long distance. Otherwise (S212: NO), the selection execution unit 403 proceeds to step S213 to select the crowd skeleton model.

After the long-distance skeleton model is selected in step S213, the selection result output unit 404 outputs the selection result, and the processing of the skeleton detection model selection unit 302 ends. In step S214, the same applies to a case in which the crowd skeleton model is selected.

As described above, according to the skeleton detection system of the present embodiment, it is possible to implement the resource saving skeleton detection with the high accuracy and the high speed by using a skeleton model with less keypoints. At this time, by selecting a skeleton model corresponding to the skeleton detection scene and eliminating an unnecessary keypoint and a keypoint which is difficult to be detected, it is possible to achieve a purpose of performing skeleton detection such as the number-of-persons count, the intruder detection, and the specific activity detection by concentrating the calculation resources on a necessary keypoint and a keypoint which is easily to be detected.

In the above example, the skeleton detection model is selected based on the purpose designated by the user and the information on the past image, but the skeleton detection model may be selected based on only one of the purpose designated by the user and the information of the past image. The skeleton detection model selection unit 302 can select a skeleton detection model based on a condition different from the above conditions. For example, the skeleton detection model can be selected based on an imaging condition of an imaging device such as the angle of view, a setting height, an elevation and depression angle, and the like, an imaging time of an image, a type of competition of an imaging target, and the like.

### Second Embodiment

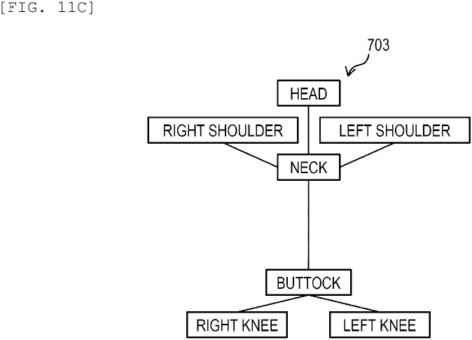

As another embodiment, a method of selecting a skeleton detection model according to a physical condition related to skeleton detection, rather than a content of an image, such as a frame rate, an image resolution, a usable calculation resource (hardware specification and resource occupancy rate), and the like, will be described. The frame rate, the image resolution, and the usable calculation resource are predetermined conditions for the skeleton detection, and are information included in a skeleton detection scene of the skeleton detection model. In the present embodiment, one skeleton detection model is selected from skeleton detection models in which the number of detected keypoints is changed stepwise as shown in FIGS. 11A to 11C. Accordingly, it is possible to select an appropriate skeleton detection model for the calculation resource.

FIGS. 11A to 11C show skeleton definition models 701, 702, and 703 in which the number of the keypoints is different. In this order, the number of the keypoints and the number of the skeletons are large, and a calculation cost for the skeleton detection is also large. The skeleton detection models corresponding to the skeleton definition models 701, 702, and 703 are prepared as selection candidates.

The calculation cost of the skeleton detection changes in proportion to the frame rate and image resolution to be processed. Therefore, for example, by selecting the skeleton model according to the image resolution and the usable calculation resource, skeleton detection processing can be performed at a required frame rate. The frame rate is, for example, a frame rate of a moving image captured or a frame rate of a skeleton detection processing designated in advance. The frame rate and the image resolution can be acquired from a camera that captures an image or acquired from a user. The usable calculation resource can be acquired from an operating system executed by the skeleton detection system 3.

For example, the skeleton detection system 3 stores long-distance skeleton detection models in which the number of the keypoints is different and crowd skeleton detection models in which the number of the keypoints is different. The skeleton detection model selection unit 302 selects one type of the long-distance skeleton detection model or the crowd skeleton detection model according to the method described in the first embodiment, and then further selects one skeleton detection model having the appropriate number of the keypoints from the selected type of the skeleton detection model.

For example, the skeleton detection model selection unit 302 can calculate a necessary calculation resource from the number of the keypoints and the number of the skeletons of the skeleton detection model, and the required frame rate and image resolution. The number of the keypoints and the number of the skeletons of the skeleton detection model are stored in the skeleton definition model summary table described with reference to FIG. 8A.

The skeleton detection model selection unit 302 selects a skeleton detection model such that an estimated calculation cost falls within the usable calculation resource. The skeleton detection model selection unit 302 can select, for example, a skeleton detection model having the largest number of the keypoints and the skeletons in a condition of the required frame rate, image resolution, and usable calculation resource. When there is no skeleton detection model that satisfies the condition, the skeleton detection model having the smallest number of the keypoints and the skeletons may be selected.

The skeleton detection system 3 may perform the determination only on the above physical condition without performing the determination described with reference to the first embodiment, and select one skeleton detection model from the skeleton detection models in which the number of the keypoints and the number of the skeletons is different.

The invention is not limited to the above embodiments, and includes various modified embodiments. For example, the above embodiments are described in detail for easy understanding of the invention, and the invention is not necessarily limited to those including all configurations described above. A part of a configuration of one embodiment can be replaced with a configuration of another embodiment, and a configuration of another embodiment can be added to the configuration of the one embodiment. A part of the configuration of each embodiment may be added to, deleted from, or replaced with another configuration.

Each of the configurations, functions, processing units, or the like described above may be implemented by hardware by designing a part or all of them with, for example, an integrated circuit. The above configurations, functions, or the like may also be implemented by software by interpreting and executing a program for implementing respective functions by the arithmetic device. Information such as a program, a table, and a file for implementing the respective functions can be stored in a recording device such as a memory, a hard disk, and a solid state drive (SSD), or a recording medium such as an IC card or an SD card.

Further, control lines and information lines are those that are considered necessary for the description, and not all the control lines and the information lines on the product are necessarily shown. In practice, it may be considered that almost all configurations are connected to each other.

1. A skeleton detection system, comprising:
one or more arithmetic devices; and
one or more storage devices, wherein
the one or more storage devices store
a target image for use in skeleton detection, and
a plurality of skeleton detection models respectively corresponding to a plurality of skeleton definition models configured to define different skeletons, and
the one or more arithmetic devices
determine a predetermined condition for the skeleton detection of the target image,
select a first skeleton detection model from the plurality of skeleton detection models based on a result of the determination, and
execute the skeleton detection of the target image by the first skeleton detection model, wherein
the target image is a frame image in a moving image, and
the one or more arithmetic devices select the first skeleton detection model from the plurality of skeleton detection models based on a skeleton detection result in a past frame image in the moving image.

2. The skeleton detection system according to claim 1, wherein
the predetermined condition includes at least one of a condition related to a content of the target image, a condition related to an arithmetic resource for the skeleton detection, a condition related to an imaging device configured to capture the target image, a condition related to a content of an image prior to the target image, and a condition designated by a user.

3. (canceled)

4. The skeleton detection system according to claim 1, wherein
the one or more arithmetic devices select the first skeleton detection model from the plurality of skeleton detection models based on a detection result of a keypoint in a skeleton detection result in the past frame image.

5. The skeleton detection system according to claim 1, wherein
the one or more arithmetic devices select the first skeleton detection model from the plurality of skeleton detection models based on a distance between a person in the target image and an imaging device for the target image.

6. The skeleton detection system according to claim 1, wherein
the one or more arithmetic devices select the first skeleton detection model from the plurality of skeleton detection models based on the number of persons in the target image.

7. A skeleton detection system, comprising:
one or more arithmetic devices; and
one or more storage devices, wherein
the one or more storage devices store
a target image for use in skeleton detection, and
a plurality of skeleton detection models respectively corresponding to a plurality of skeleton definition models configured to define different skeletons, and
the one or more arithmetic devices
determine a predetermined condition for the skeleton detection of the target image,
select a first skeleton detection model from the plurality of skeleton detection models based on a result of the determination, and
execute the skeleton detection of the target image by the first skeleton detection model, wherein
the one or more arithmetic devices select the first skeleton detection model from the plurality of skeleton detection models based on a purpose of performing skeleton detection designated by a user.

8. A skeleton detection system, comprising:
one or more arithmetic devices; and
one or more storage devices, wherein
the one or more storage devices store
a target image for use in skeleton detection, and
a plurality of skeleton detection models respectively corresponding to a plurality of skeleton definition models configured to define different skeletons, and
the one or more arithmetic devices
determine a predetermined condition for the skeleton detection of the target image,
select a first skeleton detection model from the plurality of skeleton detection models based on a result of the determination, and
execute the skeleton detection of the target image by the first skeleton detection model, wherein
the one or more arithmetic devices select the first skeleton detection model from the plurality of skeleton detection models such that an estimated calculation cost of the skeleton detection falls within a usable calculation resource.

9. (canceled)

10. The skeleton detection system according to claim 7, wherein
the predetermined condition includes at least one of a condition related to a content of the target image, a condition related to an arithmetic resource for the skeleton detection, a condition related to an imaging device configured to capture the target image, a condition related to a content of an image prior to the target image, and a condition designated by a user.

11. The skeleton detection system according to claim 8, wherein
the predetermined condition includes at least one of a condition related to a content of the target image, a condition related to an arithmetic resource for the skeleton detection, a condition related to an imaging device configured to capture the target image, a condition related to a content of an image prior to the target image, and a condition designated by a user.

12. The skeleton detection system according to claim 7, wherein
the one or more arithmetic devices select the first skeleton detection model from the plurality of skeleton detection models based on a distance between a person in the target image and an imaging device for the target image.

13. The skeleton detection system according to claim 8, wherein
the one or more arithmetic devices select the first skeleton detection model from the plurality of skeleton detection models based on a distance between a person in the target image and an imaging device for the target image.

14. The skeleton detection system according to claim 7, wherein
the one or more arithmetic devices select the first skeleton detection model from the plurality of skeleton detection models based on the number of persons in the target image.

15. The skeleton detection system according to claim 8, wherein
the one or more arithmetic devices select the first skeleton detection model from the plurality of skeleton detection models based on the number of persons in the target image.
